(19) United States
(12) Patent Application Publication
(10) Pub. No.: US 2020/0317063 A1
(43) Pub. Date: Oct. 8, 2020

(54) DRIVE ARRANGEMENT

(71) Applicant: McLaren Applied Technologies Limited, Woking, Surrey (GB)

(72) Inventors: Anthony Richard GLOVER, Guildford (GB); Robert BOWYER, Fulham, London (GB)

(73) Assignee: McLaren Applied Technologies Limited, Woking, Surrey (GB)

(21) Appl. No.: 16/304,104

(22) PCT Filed: May 23, 2017
(86) PCT No.: PCT/GB2017/051438

§ 371 Date: Nov. 21, 2018

(30) Foreign Application Priority Data
May 23, 2016 (GB) 1608994.8

(51) Int. Cl. B60L 15/00; B60L 15/28; B60L 13/04; B60L 53/12; B65G 54/02

(52) U.S. Cl. CPC B60L 15/005; B60L 15/28; B65G 2811/092; B60L 53/12; B65G 54/02; B60L 13/04

(57) ABSTRACT

A drive arrangement for moving a body along a path with respect to first and second media guides, the first media guide conveying a medium at a first velocity along the path and the second media guide conveying the medium at a second velocity different to the first velocity along the path, the drive arrangement being configured to (a) interact with the medium of the first media guide so as to extract energy therefrom and thereby develop a reaction force against the first media guide for driving the body to move along the path, and (b) interact with the medium of the second media guide by means of energy extracted from the medium of the first media guide so as to develop a reaction force against the second media guide for driving the body to move along the path.

### FIELD OF DISCLOSURE

This invention relates to drive arrangement for moving a body.

### BACKGROUND OF THE INVENTION

Traditional methods of moving a body may involve providing the body with a drive arrangement that itself can be used to move the body by acting against some external media, for instance an electric motor which can be used to drive a wheel against a track, or providing the body with at least one component that can be acted on by an external drive arrangement, for instance a permanent magnet attached to the body that is caused to move by a magnetic field acting on the permanent magnet. The body may be a vehicle, may be any carriage for cargo that can be driven to move that cargo from place to place. The cargo may be passengers in the form of human beings or other lifeforms. The cargo may be objects such as food, minerals or other objects. The vehicle may therefore be a car, bus, train, and lorry and may also be a carriage such as an elevator (also known as a lift) carriage, or object carrying pod.

In the case of a drive arrangement provided in attachment to the body that generates force to move the body, the method requires that the drive arrangement carry most, if not all, of the energy that the drive arrangement requires for any given journey, carry another means of generating the electrical energy or require a separate power source to be provided alongside the transit path of the body. This can make the drive arrangement attached to the body bulky and/or heavy because of the power requirements of the drive arrangement.

One system that attempts to address the problem of energy supply to a drive arrangement on a body is provided by Grotstollen, Horst. “The design of long-stator linear motor drives for railcab test track.” Journal of Power Electronics 5, no. 2 (2005): 166-172. In this system, a doubly-fed long-stator linear motor is used to power and provide motive force to individual carriages of a railway system. One part of the linear motor is attached to the carriage and the other part of the linear motor is provided along the track. The part that is provided on along the track are long-stators which are equipped with three-phase windings. The three-phase windings mean that individual stator pieces, which are each polarised according to one of the three phases, positioned along the direction of movement of the track can be polarised in such a way as to generate a moving magnetic field which moves in one-direction along the track. The part, a secondary component, that is provided on the carriage is also capable of generating a moving magnetic field as it is configured with a secondary part of the linear motor comprising pieces which are also wound with three-phase windings. The motion of the carriage in the direction of the moving magnetic field generated by the stator is controlled by varying the amplitude and frequency of the magnetic field generated by the secondary component.

The carriage described in the above referenced document comprises an on-board power supply in the form of a battery for storing energy for use in powering the carriage and powering on-board components such as lights. This on-board power supply can be charged from energy provided by the magnetic field generated by the stator. However, this energy transfer can only take place when the carriage is operating within one of two specific operating conditions depending on whether the carriage is using the magnetic field generated by the stator to provide thrust or braking to the carriage. In both cases energy transfer to the on-board power supply is dependent on the speed of the carriage relative to the speed of propagation of the magnetic field which are associated with the speed at which the magnetic field of the secondary piece moves along the secondary piece. This condition, in effect, sets the maximum long-term speed of the carriage because the on-board power store will be depleted whilst the carriage uses energy from that store to travel at speeds greater than the limit speed that permits charging. A larger on-board power store may be provided on the carriage but this may increase the weight and bulk of the carriage.

In the case of a drive arrangement provided externally to the body that is capable of moving the body by acting on a component provided on the body, the method may require complicated drive arrangements where the motion of more than one body is to be controlled by the drive arrangement. This is because the drive arrangement may need to provide different forces to the bodies at the same time thus meaning the control requirements of the drive arrangement may be complicated.

Examples of systems where the drive arrangement is provided externally to the body that are capable of acting on at least one component on the body are the Beckhoff XTS (eXtended Transport System) and the ThyssenKrupp multi elevator system. In each case permanent magnets are used on the bodies that the drive arrangement is configured to provide forces to so that those bodies can move. The drive arrangements comprise linear motors that produce magnetic field waves which interact with the permanent magnets present on the bodies to induce movement of the permanent magnets, and thus of the bodies. In each case, a complicated drive arrangement is used to permit the separate control of each of the bodies that operates in the system. The linear motors can be made up of small individual segments which can be individually controlled to generate a local magnetic field wave that induces the required movement of the permanent magnets attached to a particular body.

There is therefore a need for an improved drive arrangement for moving a body which addresses the problems outlined above.

### SUMMARY OF THE INVENTION

According to a first aspect of the present invention there is provided a drive arrangement for moving a body along a path with respect to first and second media guides, the first media guide conveying a medium at a first velocity along the path and the second media guide conveying the medium at a second velocity different to the first velocity along the path, the drive arrangement being configured to (a) interact with the medium of the first media guide so as to extract energy therefrom and thereby develop a reaction force against the first media guide for driving the body to move along the path, and (b) interact with the medium of the second media guide by means of energy extracted from the medium of the first media guide so as to develop a reaction force against the second media guide for driving the body to move along the path.

The drive arrangement may be configured for operation in a first drive mode wherein the amount of energy extracted from the medium of the first media guide is in equilibrium with the energy used to develop the reaction forces against the second media guide. The drive arrangement may be configured to, in the first drive mode, drive the body to move along the path whilst the amount of energy extracted from the medium of the first media guide remains in equilibrium with the energy used to develop the reaction force against the second media guide.

The first velocity and the second velocity may be opposite in direction. The magnitude of the first velocity may be equal to the magnitude of the second velocity. The drive arrangement may be configured to interact with the medium of the second media guide by means of energy substantially wholly extracted from the medium of the first media guide simultaneously with the drive arrangement developing a reaction force against the first media guide for driving the body to move along the path.

The drive arrangement may comprise an energy store configured to store energy extracted from the medium of the first media guide. The drive arrangement may be configured to, in a second mode of operation, interact with the medium of the second media guide to develop a reaction force against the second media guide by means of energy stored in the energy store that has previously been extracted from the medium of the first media guide. The drive arrangement may be configured to, in a second mode of operation, interact with the medium of the second media guide by means of energy stored in the energy store that has previously been extracted from the medium of the first media guide whilst developing a reaction force against the first media guide.

The drive arrangement may be configured so as to be capable of (a) interacting with the medium of the second media guide so as to extract energy therefrom and thereby developing a reaction force against the second media guide for driving the body to move along the path, and (b) interacting with the medium of the first media guide by means of energy extracted from the medium of the second media guide so as to develop a reaction force against the first media guide for driving the body to move along the path. The drive arrangement may further being for moving a body along a second path with respect to third and fourth media guides, the third media guide may convey a medium at a third velocity along the second path and the fourth media guide may convey the medium at a fourth velocity different to the third velocity along the second path, the drive arrangement may be configured for (a) interacting with the medium of the third media guide so as to extract energy therefrom, and (b) interacting with the medium of the fourth media guide by means of energy extracted from the medium of the third media guide so as to develop a reaction force against the fourth media guide for driving the body to move along the path. The first and second velocities may be non-parallel to the third and fourth velocities. The first and second velocities may be perpendicular to the third and fourth velocities. The third and fourth velocities may be equal in magnitude and opposite in direction. Each of the third and fourth media guides may be constituted by elements in common with the first and second media guides.

The drive arrangement may comprise a first and second set of electromagnetic coils; wherein the medium of the first and second media guides may be a respective magnetic field wave and the drive arrangement interacts with the medium of the first media guide using the first electromagnetic coils and interacts with the medium of the second media guide using the second electromagnetic coils. The drive arrangement may be configured to cause the first electromagnetic coils to generate a first magnetic field wave and cause the second electromagnetic coils to generate a second magnetic field wave; wherein the reaction forces may be generated by means of a magnetic interaction between the respective magnetic field wave of the electromagnetic coils and the magnetic field wave of the media guides. The drive arrangement may be configured to control current flowing through the electromagnetic coils to cause the interaction with the first media guide and second media guide. The drive arrangement may be configured to control current flowing through the electromagnetic coils so that a desired current flow is maintained in each of the electromagnetic coils so as to control the first magnetic field wave and second magnetic field wave. The drive arrangement may be configured to maintain the desired current flow by transferring energy between the energy store and electromagnetic coils. The first and second sets of electromagnetic coils may be configured to be driven so that each n-th coil generates the same magnetic field at a given time. The drive arrangement may comprise a first and second set of electromagnetically polarisable pieces; wherein the first set of electromagnetic coils may be configured to magnetically polarise the first set of pieces and the second set of electromagnetic coils is configured to magnetically polarise the second set of pieces.

The medium of each of the first and second media guides may be a tangible medium; and the drive arrangement may be configured to physically interact with the medium of the first media guide and the medium of the second media guide. The medium of each of the first and second media guides may be constituted by a moveable tangible object or set of objects. The drive arrangement may comprise first and second mechanical devices; wherein the first and second mechanical devices may be configured to physically interact with a respective one of the media of the first and second media guides to generate the reaction forces. Each mechanical device may be a rotary electrical machine comprising a rotor, and the respective rotor may be mechanically connected to the respective tangible medium.

According to a second aspect of the present invention there is provided a drive system for moving a body along a path, the drive system comprising a drive arrangement as described herein, and the first media guide and second media guide; wherein the first and second media guides each comprise a set of electromagnetic coils, the first and second media guides being configured to control current flowing through their respective electromagnetic coils to cause the generation of the media of the first and second media guides. The first and second media guides may be configured to control current flowing though their respective electromagnetic coils so that a desired current flow is maintained in each of the electromagnetic coils so as to control their respective magnetic field wave.

According to a third aspect of the present invention there is provided a drive arrangement for moving a body with respect to a surface, the surface conveying a plurality of magnetic field waves at respective velocities in at least two non-parallel directions across the surface, the drive arrangement being configured to magnetically interact with a set of the magnetic field waves to develop reaction forces for driving the body across the surface, wherein the magnetic interaction with a number of the set of magnetic field waves extracts energy therefrom and the magnetic interaction with the other(s) of the set of magnetic field waves is by means of the energy extracted.

The drive arrangement may be configured for operation in a first drive mode wherein the amount of energy extracted by the magnetic interaction with the number of the set of magnetic field waves is in equilibrium with the energy used to develop the magnetic interaction with the other(s) of the set of magnetic field waves. The drive arrangement may be configured to, in the first drive mode, drive the body across the surface whilst the amount of energy extracted by the magnetic interaction with the number of the set of magnetic field waves remains in equilibrium with the energy used to develop the magnetic interaction with the other(s) of the set of magnetic field waves. The drive arrangement may be configured to magnetically interact with the other(s) of the set of magnetic field waves by means of energy substantially wholly extracted by the magnetic interaction with the number of the set of magnetic field waves.

The drive arrangement comprising an energy store configured to store energy extracted by the magnetic interaction with the number of the set of magnetic field waves. The drive arrangement may be configured to, in a second mode of operation, develop the magnetic interaction with the other(s) of the set of magnetic field waves by means of energy stored in the energy store that has previously been extracted by the magnetic interaction with the number of the set of magnetic field waves. The surface may convey pairs of magnetic field waves at different velocities along a direction; and the drive arrangement may be configured to magnetically interact with one of the pair of magnetic field waves to extract energy therefrom and magnetically interact with the other of the pair of magnetic field waves by means of the energy extracted. The surface may convey pairs of magnetic field waves at different velocities that are equal in magnitude but opposite in direction. The surface may convey magnetic field waves at respective velocities in two perpendicular directions across the surface.

The drive arrangement may comprise a plurality of electromagnetic coils; and the drive arrangement may be configured to control current flowing through the plurality of electromagnetic coils to magnetically interact with the set of the magnetic field waves to develop reaction forces for driving the body across the surface. The drive arrangement may be configured to control current flowing through the plurality of electromagnetic coils so that a desired current flow is maintained in each of the electromagnetic coils so as to control the magnetic interactions. The drive arrangement may be configured to maintain the desired current flow by transferring energy between the energy store and the electromagnetic coils.

According to a fourth aspect of the present invention there is provided a drive system for moving a body with respect to a surface, the drive system comprising a drive arrangement as described herein, and the surface conveying a plurality of magnetic field waves.

The surface may comprise an array of electromagnetic coils, the electromagnetic coils being configured to generate the plurality of magnetic field waves.

According to a fifth aspect of the present invention there is provided a drive arrangement for moving a body with respect to a motion surface defined by an array of electromagnetic coils, the array of electromagnetic coils generating: first magnetic field waves moving at first velocities along a first direction; second magnetic field waves moving at second velocities along the first direction, the second velocities being different to the first velocities; third magnetic field waves moving at third velocities along a second direction; fourth magnetic field waves moving at fourth velocities along the second direction, the fourth velocities being different to the third velocities; the drive arrangement comprising a plurality of electromagnetic coils; the drive arrangement being configured to control current flowing through the plurality of electromagnetic coils to: magnetically interact with at least one of the first magnetic field waves and at least one of the third magnetic field waves so as to extract energy therefrom and thereby develop reaction forces against the array of electromagnetic coils for driving the body along the first and second directions; and magnetically interact with at least one of the second magnetic field waves and at least one of the fourth magnetic field waves by means of energy extracted from the first magnetic field waves and third magnetic field waves to develop reaction forces against the array of electromagnetic coils for driving the body along the first and second directions.

### BRIEF DESCRIPTION OF THE FIGURES

The present invention will now be described by way of example with reference to the accompanying drawings. In the drawings:

FIG. 1 shows a schematic illustration of a drive arrangement.

FIG. 2 shows a schematic illustration of more than one set of media guides.

FIG. 3 shows a design of drive system.

FIG. 4 shows a design of stator arrangement for use in a drive system.

FIG. 5 shows a design of drive arrangement that may be used to interact with the design of stator arrangement shown in FIG. 4.

FIG. 6 shows another design of stator arrangement for use in a drive system.

FIG. 7 shows another design of drive system.

### DETAILED DESCRIPTION OF THE INVENTION

The following description is presented to enable any person skilled in the art to make and use the invention, and is provided in the context of a particular application. Various modifications to the disclosed embodiments will be readily apparent to those skilled in the art. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a drive arrangement for moving a body along a path with respect to first and second media guides. The first media guide can convey a medium at a first velocity along the path and the second media guide can convey the medium at a second velocity, different to the first velocity, along the path. The drive arrangement can be configured to (a) interact with the medium of the first media guide so as to extract energy therefrom and thereby develop a reaction force against the first media guide for driving the body to move along the path. The drive arrangement can also be configured to (b) interact with the medium of the second media guide by means of energy extracted from the medium of the first media guide so as to develop a reaction force against the second media guide for driving the body to move along the path.

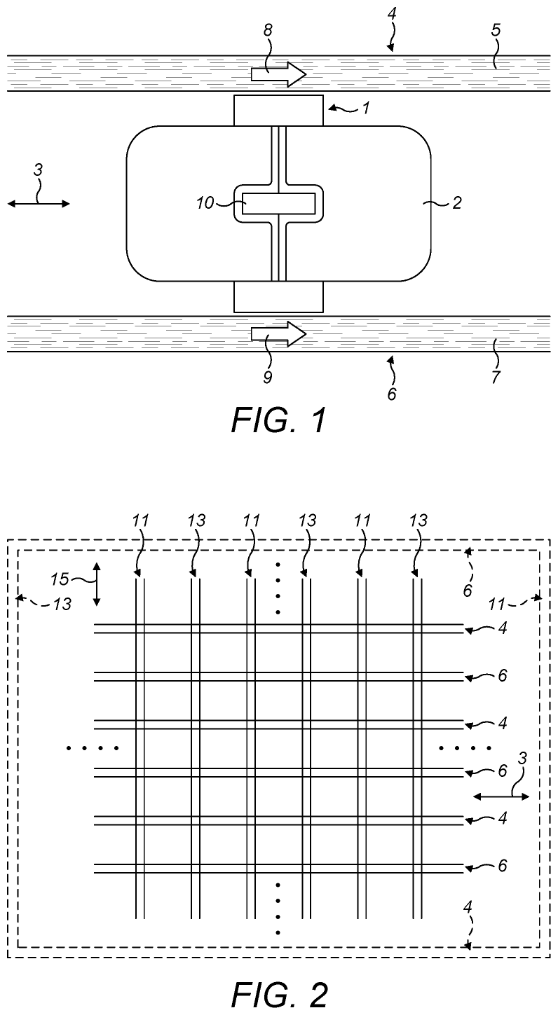

FIG. 1 shows a schematic illustration of a drive arrangement 1 for moving a body 2 along a path 3. The drive arrangement 1 interacts with the medium of a first media guide 4. The medium of first media guide 4 may be known as a first medium 5. The drive arrangement 1 interacts with the medium of a second media guide 6. The medium of second media guide 6 may be known as a second medium 7. Generally, the first medium and second medium may be the same medium to permit easy energy exchange between the drive arrangement and the two media 5, 7.

The first media guide 4 is configured to convey the first medium 5 at a first velocity 8 relative to the first media guide 4. The second media guide 6 is configured to convey the second medium 7 at a second velocity 9 relative to the second media guide 6. The difference between the velocities of the media of the first and second media guides 4, 6 permits the drive arrangement 1 to interact with those media to move the body 2 along the path 3. This is because the drive arrangement 1 is then able to interact with one of the first and second media 5, 7 to extract energy therefrom and, simultaneously, develop a reaction force against the same one of the first and second media guides 4, 6 to drive the body 2 along the path and interact with the medium of the other of the media guides by means of the energy extracted to develop a reaction force against the other of the media guides to drive the body to move along the path.

In a preferred embodiment the first velocity and second velocity are opposite in direction. The control of the media 5, 7 of the first and second media guides 4, 6 may be simplified by the magnitude of the first and second velocities being equal.

The drive arrangement may be configured to (a) interact with the medium of the first media guide so as to extract energy therefrom and thereby develop a reaction force against the first media guide for driving the body to move along the path, and (b) interact with the medium of the second media guide by means of energy extracted from the medium of the first media guide so as to develop a reaction force against the second media guide for driving the body to move along the path. The extraction of energy from the medium of the first media guide and use of that energy to interact with medium of the second media guide may drive the body in a first direction along the path. The drive arrangement may be configured so as to be capable of (a) interacting with the medium of the second media guide so as to extract energy therefrom and thereby developing a reaction force against the second media guide for driving the body to move along the path, and (b) interacting with the medium of the first media guide by means of energy extracted from the medium of the second media guide so as to develop a reaction force against the first media guide for driving the body to move along the path. The extraction of energy from the medium of the second media guide and use of that energy to interact with medium of the first media guide may drive the body in a second direction along the path. The first and second directions may be opposite with respect to the path.

The drive arrangement 1 may be configured to interact with the medium of the second media guide by means of energy substantially wholly extracted from the medium of the first media guide simultaneously with the drive arrangement developing a reaction force against the first media guide for driving the body to move along the path. In this way the drive arrangement 1 generates a force from both the interaction with the medium 5 of the first media guide 4 and the medium 7 of the second media guide 6 to move the body 2 along the path 3.

The drive arrangement 1 may be capable of operating without the need for an external energy source beyond the energy that is extracted from the medium of the first and/or second media guides. The drive arrangement 1 may be capable of operating so that there is an energy balance between the energy extracted from one of the media of the first and second media guides 4, 6 to generate a reaction force against that media guide 4, 6 and the energy used to interact with the other of the media of the first and second media guides 4, 6 to generate a reaction force against that media guide 4, 6. This energy balance may be such that energy extracted from a first one of the media guides is used almost instantaneously to interact with the other of the media of the media guides. Therefore, the drive arrangement may be configured to operate in a mode of operation, a first drive mode, whereby the amount of energy extracted from the medium of one media guide is in equilibrium with the energy used to develop the reaction forces against the other media guide. The energy extracted from the medium of one media guide may be the only source of energy that is used to develop the reaction forces against the other media guide. Therefore, the drive arrangement may be configured to, in the first drive mode, drive the body to move along the path whilst the amount of energy extracted from the medium of one media guide remains in equilibrium with the energy used to develop the reaction force against the other media guide.

The drive arrangement 1 may comprise an energy store 10 configured to store energy extracted from the media of the first and second media guides 4, 6. The drive arrangement may be configured to operate in a mode of operation whereby the drive arrangement interacts with one of the media of the media guides to develop a reaction force against that media guide by means of energy stored in the energy store 10 that had previously been extracted from the medium of the other of the media guides. In this case, the energy balance between energy extracted from the medium of a media guide and energy used to interact with the medium of the other media guide may occur over a period of time. This period of time is ideally short so that it is not required that the energy store be large in size.

In the case where a surfeit of energy is generated in the interaction with the medium of one of the media guides, this energy may be used to power energy consuming apparatus present on or comprised in the body 2. The energy used to power the energy consuming apparatus of the body 2 may be sourced from the energy store 10.

The drive arrangement 1 may be capable of moving the body 2 around in a motion that is not confined to movement relative to the velocities of the media of a first and second media guides 4, 6. Other media guides may also be present that the drive arrangement 1 can interact with to be able to move the body 2.

FIG. 2 shows a schematic illustration of more than one set of media guides. In FIG. 2 two sets of media guides are shown. A set of first and second media guides 4, 6 are shown running along one path, first path 3, and a set of third and fourth media guides 11, 13 are shown running along another path, second path 15. The drive arrangement 1 may therefore also be capable of moving a body along a second path 15 with respect to third and fourth medium guides 11, 13. The third media guide 11 can convey a medium at a third velocity along the second path 15 and the fourth media guide 13 conveying a medium at a fourth velocity along the second path 15. As pictured in FIG. 2, the first and second velocities may be non-parallel to the third and fourth velocities to permit movement along non-parallel first and second paths. The first and second velocities may be perpendicular to the third and fourth velocities. More generally, the media guides 4, 6, 11, 13 may define a surface over which the body may be moved by the drive arrangement. The surface may convey a plurality of media across the surface in at least two non-parallel directions.

The interaction between the drive arrangement 1 and the media of third and fourth media guides 11, 13 to move the body along second path is as described in relation to FIG. 1 and the first and second media guides 4, 6 above. In summary, the drive arrangement may be configured to be capable of (a) interacting with the medium of the third media guide so as to extract energy therefrom, and (b) interacting with the medium of the fourth media guide by means of energy extracted from the medium of the third media guide so as to develop a reaction force against the fourth media guide for driving the body to move along the path. The third and fourth velocities may be equal in magnitude and opposite in direction for the reasons as described above in relation to first and second velocities. More generally, the drive arrangement may be configured to interact with a set of the media to develop reaction forces for driving the body across the surface. The interaction with a number of the set of media extracts energy therefrom and the interaction with the other(s) of the set of media is by means of the energy extracted.

As shown in FIG. 2, the set of first and second media guides overlap with the set of third and fourth media guides. Therefore, the third and fourth media guides may be constituted by elements in common with the first and second media guides, for instance, at the positions where the media guides overlap.

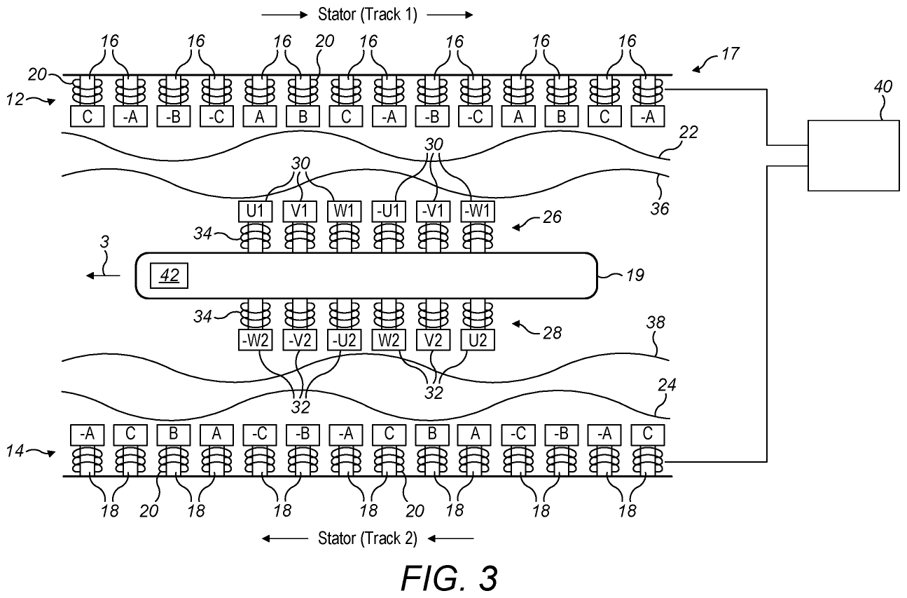

In one embodiment, the interaction between the drive arrangement 1 and the media guides 4, 6, 11, 13 may be a magnetic interaction. FIGS. 3 to 6 will be used below to describe the operation of drive arrangements which operate in this manner.

FIG. 3 shows a design of a drive system 17 for moving a body 19 along a path 3. In FIG. 3, first media guide is shown at 12 and second media guide is shown at 14.

The drive system 17 may comprise two stators 12 and 14. First and second stators 12 and 14 are together positioned along the motion path 3 of the body 16. As mentioned above, the degrees of freedom of the body 19 may be such that the motion path of the vehicle may be along a line or it may be over a plane. The motion of body 19 may be constrained so that body 19 can move along a path that is generally the same as the line that stators 12 and 14 follow. First and second stators 12, 14 may have a fixed distance between them in the direction perpendicular to the primary direction of the first and second stators 12, 14.

Each first and second media guide 12, 14 may comprise a set of electromagnetic coils 20 and the media guides may be configured to control current flowing through their respective electromagnetic coils to cause the generation of the media of the first and second media guides 12, 14. In this case, the media may be respective magnetic field waves. To enable the generation of the correct magnetic field waves on each of the first and second media guides 12, 14, the first and second media guides may be configured to control current flowing through their respective electromagnetic coils 20 so that a desired current flow is maintained in each of the electromagnetic coils. The desired current flow in any electromagnetic coil being such that the magnetic field wave of the respective media guide is generated.

Each body 19 that is part of drive system 17 may comprise two secondary magnetic components 26, 28. Each secondary component 26, 28 may comprise a set of electromagnetic coils 34. The drive arrangement of the body 19 interacts with the medium of the first media guide 12 using the first set of electromagnetic coils 34 and interacts with the medium of the second media guide 14 using the second set of electromagnetic coils 34. The first and second sets of electromagnetic coils 34 may generate a first magnetic field wave and second magnetic field wave respectively. To enable the generation of the correct magnetic field waves on each set of electromagnetic coils 34, the drive arrangement may be configured to control current flowing through the electromagnetic coils 34 to cause the interaction with the first media guide 12 and second media guide 14. The drive arrangement may be configured to control current flowing through the electromagnetic coils 34 so that a desired current flow is maintained in each of the electromagnetic coils so as to control the first magnetic field wave and second magnetic field wave.

Some or all of each stator 12, 14 and secondary component 26, 28 may comprise a plurality of stator pieces 16, 18 and a plurality of secondary pieces 30, 32 respectively. The pieces 16, 18, 30, 32 may be equally spaced along each of the stators 12, 14 and secondary components 26, 28 that have them. The secondary components 26, 28 are positioned with respect to the vehicle 19 so that during normal motion of the vehicle 19 the secondary components 26, 28 are aligned with the first and second stators 12, 14 and that the secondary pieces 30, 32 of a respective secondary component 26, 28 are spaced along the primary motion direction of the vehicle 19.

In the case that the first and second media guides comprise stator pieces, the electromagnetic coils 20 may polarise the stator pieces 16, 18. In the case that the drive system 17 comprises secondary pieces 30, the plurality of electromagnetic coils 20 may polarise the secondary pieces 30, 32. At least one electromagnetic coil 20, 34 may be associated with a respective piece to enable that piece to be polarised. An electromagnetic coil 20, 34 may be wound around each of the pieces 16, 18, 30, 32. Other configurations of electromagnetic coil 20, 34 are envisaged as being compatible with the present invention. For example, the electromagnetic coil 20, 34 may be wrapped around only part of the piece, more than one electromagnetic coil 20, 34 may be used to polarise a particular piece, not all of the pieces may be polarised by electromagnetic coils 20, 34. The pieces 16, 18, 30, 32 may be formed by slots being cut in to stator 12, 14 or secondary component 26, 28 respectively and the windings of electromagnetic coil 20, 34 may be placed in those slots and so the return of the winding may run closer to a different stator piece than the outward winding. Not all of the secondary pieces may be polarised by electromagnetic coils 34 however it is expected that in most situations each secondary piece that is present on the drive arrangement would be polarised by an electromagnetic coil 34 so as to maximise the power that is generated by the magnetic material that is being carried by the drive arrangement as part of secondary components 26, 28.

In the case of a three phase stator, the windings of every third electromagnetic coil 20, 34 may be joined together so that the polarisation generated by every third electromagnetic coil 20, 34 may be varied in unison. The direction of the windings may be alternated between neighbouring third electromagnetic coils so that neighbouring electromagnetic coils have opposite polarisation. This is as shown in FIG. 3 by the A and -A notation (and similarly for B and C) and by the Un and -Un notation (and similarly for Wn and Vn). It will be appreciated that other numbers of phases may be used to energise the coils and in which case the periodicity of the coils that are joined together may be suitably altered to suit the particular number of phases.

The electromagnetic coils 20, 34 are each capable of generating a magnetic field between a positive and negative maximum polarisation. The electromagnetic coils are connected to at least one stator controller 40 so that the variation of polarisation of the magnetic field of neighbouring electromagnetic coils between the maximum positive and negative values can be controlled so that they have different phases. The electromagnetic coils 34 located on the drive arrangement are connected to a motor controller 42 so that the variation of the polarisation of the magnetic field of neighbouring electromagnetic coils 34 between the maximum positive and negative values can be controlled so that they have different phases. This variation in the phase of the polarisation of the stator pieces is shown as magnetic field waves 22 and 24 for the first and second stators 12, 14 respectively and as magnetic field waves 36 and 38 for first and second secondary components 26, 28 respectively. In the three phase stator and secondary components 26, 28 shown in FIG. 3, the polarisation phase of the magnetic field of neighbouring electromagnetic coils 20, 24 repeats every six electromagnetic coils 20, 34. The variation of the phase of the polarisation of the magnetic field of the electromagnetic coils 20, 34 causes a travelling magnetic field wave to, in effect, be generated along each of the stators 12, 14 and secondary components 26, 28 respectively. As shown in FIG. 3, the magnetic field waves of the electromagnetic coils 20, 34 can be controlled so that they move in opposite directions along each of the first and second stators 12, 14 and the first and second secondary components 26, 28.

Generally, the magnetic field wave of a particular secondary component moves in the same direction, relative to the fixed stator, as the magnetic field wave of the stator that is associated with that secondary component. So in the case of the drive system 17 shown in FIG. 3, the magnetic field wave of the first secondary component 26 moves in the same direction as the magnetic field wave of the first stator 12 and the magnetic field wave of the second secondary component 28 moves in the same direction as the magnetic field wave of the second stator 14.

The variation of phase means that the relative polarisation of the magnetic field generated by the electromagnetic coils 20, 34 moves along each stator. The magnetic field moves in that the polarisation of the magnetic field generated by the electromagnetic coils 20, 34 varies over time which means that a particular polarisation moves along the series of electromagnetic coils 20, 34. The magnetic field associated with each stator 12, 14 and secondary component 26, 28 varies with time by virtue of the current flowing through each electromagnetic coil 20, 34 being altered over time to vary the amount and direction of polarisation of the magnetic field associated with each electromagnetic coil 20, 34.

In the drive arrangement described above with reference to FIG. 3, the reaction forces may be generated by means of a magnetic interaction between the respective magnetic field wave of the electromagnetic coils 34 of the secondary components 26, 28 and the magnetic field wave of the electromagnetic coils 20 of the stators 12, 14. In this way, each secondary component and stator pair acts as a doubly fed linear motor in that both the stator and secondary component can each be energised and de-energised by the electromagnetic coils to thus generate a force between the stator and secondary component. The polarisation of the secondary components 26, 28 can be controlled to vary the force generated between each secondary component 26, 28 and the associated stator 12, 14.

The drive arrangement can vary the velocity at which the magnetic field waves of secondary components 26, 28 moves along the secondary components. By varying this velocity, the drive arrangement can move the body by interacting with one of the magnetic field waves of stators 12, 14 to extract energy therefrom and develop a reaction force against that stator and interact with the other of the magnetic field waves of stators 12, 14, using the extracted energy, to develop a reaction force against the other stator 12, 14. The magnetic field wave that the drive arrangement extracts energy from and the magnetic field wave that the drive arrangement uses energy to react against at any given time is determined based on the power balance between each stator/secondary component pair. The power generated or consumed by a particular stator/secondary component pair is dependent on the force being generated by that stator/secondary component pair and the velocity at which the magnetic field wave of the secondary component is moving relative to the secondary component that is generating the respective magnetic field wave. It is therefore, in effect, the velocity at which the magnetic field wave of the secondary component is moving relative to the body 2 that can be driven by drive arrangement 1. Hence, at any given time, each stator/secondary component pair may be a net consumer or net generator of power within the system. The drive arrangement can cause the body to remain stationary by causing the magnetic field waves generated by the first and second secondary components to move at the same velocity, relative to the drive arrangement, as the velocity of the respective magnetic field wave generated by first and second stators 12, 14 relative to the ground.

As mentioned above, the degrees of freedom of motion of the body 19 may be such that the body 19 may be free to move along a line or may be free to move over a plane. The plane may be a surface that is defined by the electromagnetic coils of the stators. In this respect the plane does not need to be a planar surface but may have contours to the surface. In the first design of drive system 17 described above the body may be free to move along a line in either direction depending on the control of the electromagnetic coils described above. In other designs of drive system 17 the body 19 may be free to move over a plane. In such a system, instead of the body 19 potentially running along a track the body 19 may have a motion system that permits it to move in any direction over the plane. Such a motion system may involve the body 19 comprising one or more multidirectional wheels that permit the body to move over the plane or the body may float above the plane, for instance on a cushion of air or by using a magnetic levitation system.

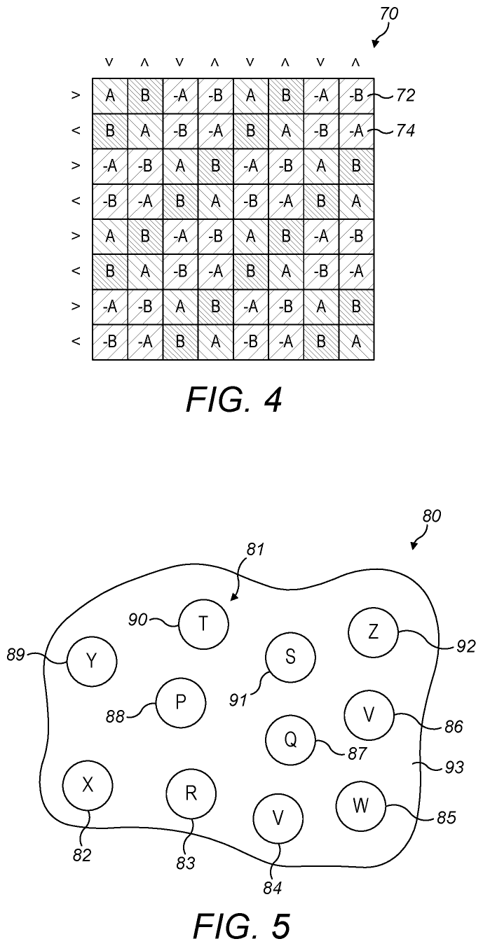

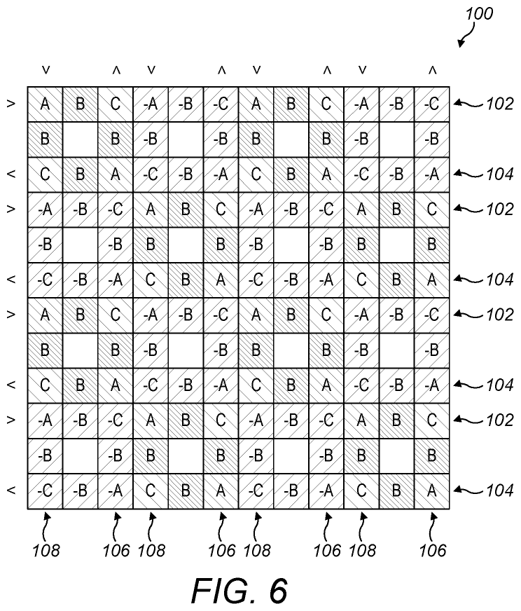

FIG. 4 shows a second design of stator 70 for use in a drive system 17. The design shown in FIG. 4 is a two-phase design but three phase designs are also compatible with this arrangement, by way of example, as shown in FIG. 6. In the design shown in FIG. 4, the body 19 may be capable of movement over a surface defined by the stators 70. In such a system the body is capable of moving in two dimensions across the plane, along the paths defined by the two sets of media guides. A magnetic field wave in two directions is produced by the stator array 70. The stator array 70 comprises a plurality of stator pairs 12, 14 as shown and described in relation to FIG. 3. The stator pairs generate a magnetic field wave in one dimension as shown by stators 72 and 74 in FIG. 4. The arrows of FIG. 4 show the direction of movement of the magnetic field wave with first stator 72 generating a magnetic field wave that moves in one direction and the second stator 74 generating a magnetic field wave that moves in the other, opposite direction.

The first and second stators 72, 74 have electromagnetic coils associated with them for generating the magnetic field waves as described above in relation to FIG. 3. In the case of the two-phase design shown in FIG. 4 every other electromagnetic coil along the line of the stator is configured so that they energise in a like manner. As shown by the A and -A notation every other electromagnetic coil is configured to generate an oppositely polarised magnetic field.

As shown in FIG. 4, by forming an array of stators that can each produce a magnetic field wave that can move along one direction, the array of stators also produces a moving magnetic field wave in a second direction perpendicular to the first direction.

The electromagnetic coils of the stators may define a surface over which the body can be moved. The electromagnetic coils of the surface may generate and convey a plurality of magnetic field waves at respective velocities in at least two non-parallel directions across the surface. As shown in FIG. 4, the electromagnetic coils may be configured to generate and convey magnetic field waves at respective velocities in two perpendicular directions across the surface. The electromagnetic coils may be configured to convey pairs of magnetic field waves at different velocities that are equal in magnitude but opposite in direction. In this way the drive arrangement can interact with each of these pairs to draw energy from one magnetic field wave and use that energy to interact with the other magnetic field wave. More generally, the drive arrangement can draw energy from some of the magnetic field waves and use that energy to interact with others.

An example drive arrangement 80 is shown in FIG. 5 that may be used to interact with the stator array 70 as shown by the example in FIG. 4. The drive arrangement 80 comprises a secondary component array 81 that can interact with the magnetic wave field produced by the stator array 70 to move the body. The secondary component array 81 comprises a plurality electromagnetic coils 82-92 that can each be configured as discussed in relation to FIG. 3 above. The number of electromagnetic coils shown in FIG. 5 is for example only. It will be appreciated that the number, and layout, of the electromagnetic coils may be adjusted to suit (i) the drive requirements of the drive arrangement 80 and/or (ii) the configuration of the stator array with which it interacts. The electromagnetic coils 82-92 may be commutated individually so that the individual electromagnetic coils can create magnetic fields as required to interact with the magnetic field waves of the stator array to drive the body in any direction across the stator array. The individual commutation is indicated in FIG. 5 by the P to Z notation. By commutating the electromagnetic coils individually, the drive arrangement can create magnetic fields which may permit the drive arrangement to have a yaw degree of freedom, i.e. the drive arrangement can cause the body to rotate relative to the stator array. The electromagnetic coils, shown generally at 82-92, may induce a magnetic field in secondary component pieces, also shown generally at 82-92, about which the electromagnetic coils may be wrapped as discussed above. Those secondary component pieces may be joined together by magnetically susceptible material 93. Depending on the configuration of the stator array and the drive requirements of the drive arrangement 80, at least some of the electromagnetic coils 82-92 may be driven together as described above. Some of the electromagnetic coils may be driven in phase with each other and others may be driven with an inverse phase. The commutation of the electromagnetic coils may be such that the secondary component is in energy equilibrium.

A three-phase version of the two-dimensional stator array described with reference to FIG. 4 is shown in FIG. 6. In the design of stator array shown in FIG. 6, the body may again be capable of movement over a plane defined by the stators 100. The three-phase stator array of FIG. 6 is capable of generating magnetic field waves in two-dimensions. The stator array comprises stators 102, 104 running in a first direction and stators 106, 108 running in a second direction. The stators running in each of the two directions cross at points where the stators have electromagnetic coils generating common magnetic fields. The stators running in the two directions can therefore share electromagnetic coils at those crossing points. FIG. 6 shows those crossing points as occurring at the A, -A and C, -C phase electromagnetic coils but it will be appreciated that the stators could be shifted in either direction so that the other phases of electromagnetic coil are used as the crossing points. The arrows of FIG. 6 showing the direction of movement of the magnetic field wave with first stators 102 generating a magnetic field wave that moves in one direction of a first axis of the stator array 100 and the second stators 104 generating a magnetic field wave that moves in the other, opposite direction of a first axis of the stator array 100. Third stators 106 generate a magnetic field wave that moves in one direction of a second axis of the stator array 100 and the fourth stators 108 generating a magnetic field wave that moves in the other, opposite direction of a second axis of the stator array 100.

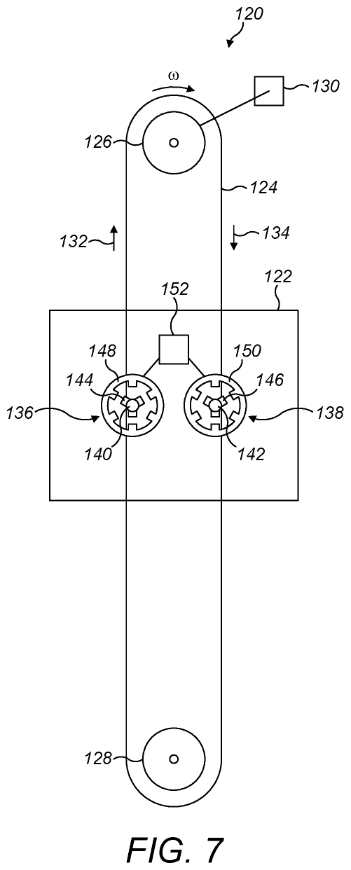

In another embodiment, the interaction between the drive arrangement 1 and the media guides 4, 6, 11, 13 may be a physical interaction. FIG. 7 will be used below to describe the operation of drive arrangements which operate in this manner. An alternative configuration which uses the same fundamental principles as the above describes systems is shown in FIG. 7. FIG. 7 shows a drive system 120 where the interaction between the media and the drive arrangement is a physical interaction.

The medium of each of the first and second media guides 132, 134 may be a tangible medium. In the example shown in FIG. 7, the medium of each of the first and second media guides is a moveable tangible object. The moveable tangible object may be a belt 124. The drive system 120 therefore comprises a belt 124 disposed between first and second wheels 126, 128. At least one of wheels 126, 128 may be driven by a motor 130. The belt 124 is therefore driven around a loop between first and second wheels 126, 128. The belt 124 may be driven at an angular speed w around the loop. Therefore, one side of belt 124 is driven in a first direction shown by arrow 132 and may form the media of first media guide and the other side of belt 124 is driven in a second direction shown by arrow 134 and may form the media of second media guide. The first direction may be in a generally upwards direction 132 and the second direction may be in a generally downwards direction 134 as pictured in FIG. 7 or vice-versa.

The drive arrangement may comprise mechanical devices which physically interact with the media of the media guides. The drive arrangement may comprise first and second mechanical devices 136, 138 configured to physically interact with a respective one of the media of the first and second media guides to generate the reaction forces described above with reference to FIGS. 1 and 2. The first mechanical device 136 may be configured to physically interact with the media, one side 132 of belt 124, of first media guide and the second mechanical device 138 may be configured to physically interact with the media, other side 134 of belt 124, of second media guide.

As shown in FIG. 7, the first mechanical device may be an electrical machine 136 and second mechanical device may be an electrical machine 138. The electrical machines 136, 138 may be rotary electrical machines comprising a rotor 140, 142. The respective rotor may be mechanically connected to the respective tangible medium, in this case either side 132, 134 of belt 124. This means that when the belt 124 moves relative to the vehicle 122 each rotating shaft 140, 142 rotates about a respective rotational axis.

Any conventional electrical machine may be used as electrical machines 136, 138. By way of example, each electrical machine 136, 128 may comprise a plurality of rotor pieces 144, 146 attached to rotor 140, 142. Each rotor 140, 142 rotating about a respective rotational axis. Thus rotor pieces 144, 146 rotate about the respective rotational axis of rotor 140, 142. Electrical machines 136, 138 may each further comprise a stator 148, 150 and each stator 148, 150 may comprise a plurality of stator pieces 148, 150. The rotor pieces 144, 146 and stator pieces 148 150 may be constituted by electromagnetic coils and those electromagnetic coils be configured to generate magnetic fields. Alternatively, electromagnetic coils may be associated with each rotor piece 144, 146 and/or stator piece 148, 150 so as to be capable of separately polarising each rotor piece 144, 146 and/or stator piece 148, 150. Rotor pieces 144, 146 and/or stator pieces 148, 150 may be constituted by permanent magnetic material. Thus, stators 148, 150 can magnetically interact with a respective rotor 140, 142. The electrical machines 136, 138 may be connected to an electrical machine controller 152 configured to control the drive of electrical machines 136, 138. The drive of electrical machines may be controlled to generate the required reaction forces against belt 124. The magnetic polarisation of the rotors and stators may be controlled as described in relation to FIGS. 3 to 6 to generate reaction forces against belt 124.

Using the physical interaction of the drive arrangement with the tangible media the drive arrangement is capable of moving the body 122. Taking the example of body 122 travelling in the first direction, i.e. upwards: First electrical machine 136 can resist the rotation of rotor 148 caused by the movement of belt 124. Such resistance reduces the rotational speed of rotor 148 which causes electrical machine 136 and thus body 122 to be drawn upwards. As electrical machine 136 is taking energy out of rotor 148, electrical machine 136 acts as a generator during motion of the vehicle in the movement direction of belt 124 at the point where electrical machine 136 interacts with band 124. This energy can be stored by controller 152 for later use and/or can be used by controller 152 to provide power to second electrical machine 150. Energy can be provided to second electrical machine 150 to drive rotor 142 in the rotation direction of the rotor due to band 124. By driving rotor 142 in the rotation direction it again provides an upward force on body 122. In this case, electrical machine 138 acts as a motor during motion of the vehicle in the opposite movement direction to that of band 124 at the point where electrical machine 138 interacts with band 124.

It will be appreciated that electrical machines 136, 138 may operate as motors or generators as required depending on whether they are required to drive in the direction of motion of belt 124 where the electrical machine 136, 138 interacts with the belt 124 or are required to drive in the direction opposite to the motion of the band 124 where the electrical machine 136, 138. Also, as gravity has an effect on vehicle 122 in vertical operation the electrical machines 136, 138 or stator/secondary component pairs of FIGS. 1 to 6 may be required to provide force to the vehicle for the vehicle to be stationary.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A drive arrangement for moving a body along a path with respect to first and second media guides, the first media guide conveying a medium at a first velocity along the path and the second media guide conveying the medium at a second velocity different to the first velocity along the path, the drive arrangement being configured to (a) interact with the medium of the first media guide so as to extract energy therefrom and thereby develop a reaction force against the first media guide for driving the body to move along the path, and (b) interact with the medium of the second media guide by means of energy extracted from the medium of the first media guide so as to develop a reaction force against the second media guide for driving the body to move along the path.

2. A drive arrangement as claimed in claim 1, the drive arrangement being configured for operation in a first drive mode wherein the amount of energy extracted from the medium of the first media guide is in equilibrium with the energy used to develop the reaction forces against the second media guide.

3. A drive arrangement as claimed in claim 2, the drive arrangement being configured to, in the first drive mode, drive the body to move along the path whilst the amount of energy extracted from the medium of the first media guide remains in equilibrium with the energy used to develop the reaction force against the second media guide.

4. A drive arrangement as claimed in claim 1, wherein the first velocity and the second velocity are opposite in direction.

5. A drive arrangement as claimed in claim 4, wherein the magnitude of the first velocity is equal to the magnitude of the second velocity.

6. A drive arrangement as claimed in claim 1, the drive arrangement being configured to interact with the medium of the second media guide by means of energy substantially wholly extracted from the medium of the first media guide simultaneously with the drive arrangement developing a reaction force against the first media guide for driving the body to move along the path.

7. A drive arrangement as claimed in claim 1, the drive arrangement comprising an energy store configured to store energy extracted from the medium of the first media guide.

8. A drive arrangement as claimed in claim 7, the drive arrangement being configured to, in a second mode of operation, interact with the medium of the second media guide to develop a reaction force against the second media guide by means of energy stored in the energy store that has previously been extracted from the medium of the first media guide.

9. A drive arrangement as claimed in claim 8, the drive arrangement being configured to, in a second mode of operation, interact with the medium of the second media guide by means of energy stored in the energy store that has previously been extracted from the medium of the first media guide whilst developing a reaction force against the first media guide.

10. A drive arrangement as claimed in claim 1, the drive arrangement being configured so as to be capable of (a) interacting with the medium of the second media guide so as to extract energy therefrom and thereby developing a reaction force against the second media guide for driving the body to move along the path, and (b) interacting with the medium of the first media guide by means of energy extracted from the medium of the second media guide so as to develop a reaction force against the first media guide for driving the body to move along the path.

11. A drive arrangement as claimed in claim 1, the drive arrangement further being for moving a body along a second path with respect to third and fourth media guides, the third media guide conveying a medium at a third velocity along the second path and the fourth media guide conveying the medium at a fourth velocity different to the third velocity along the second path, the drive arrangement being configured for (a) interacting with the medium of the third media guide so as to extract energy therefrom, and (b) interacting with the medium of the fourth media guide by means of energy extracted from the medium of the third media guide so as to develop a reaction force against the fourth media guide for driving the body to move along the path.

12. A drive arrangement as claimed in claim 11, wherein the first and second velocities are non-parallel to the third and fourth velocities, and the first and second velocities are perpendicular to the third and fourth velocities.

13. (canceled)

14. A drive arrangement as claimed in claim 12, wherein the third and fourth velocities are equal in magnitude and opposite in direction.

15. A drive arrangement as claimed in claim 11, wherein each of the third and fourth media guides are constituted by elements in common with the first and second media guides.

16. A drive arrangement as claimed in claim 1, the drive arrangement comprising a first and second set of electromagnetic coils; wherein the medium of the first and second media guides is a respective magnetic field wave and the drive arrangement interacts with the medium of the first media guide using the first electromagnetic coils and interacts with the medium of the second media guide using the second electromagnetic coils; the drive arrangement being configured to cause the first electromagnetic coils to generate a first magnetic field wave and cause the second electromagnetic coils to generate a second magnetic field wave; wherein the reaction forces are generated by means of a magnetic interaction between the respective magnetic field wave of the electromagnetic coils and the magnetic field wave of the media guides, and the drive arrangement being configured to control current flowing through the electromagnetic coils to cause the interaction with the first media guide and second media guide.

17.-18. (canceled)

19. A drive arrangement as claimed in claim 16, the drive arrangement being configured to control current flowing through the electromagnetic coils so that a desired current flow is maintained in each of the electromagnetic coils so as to control the first magnetic field wave and second magnetic field wave.

20. A drive arrangement as claimed in claim 19, the drive arrangement comprising an energy store configured to store energy extracted from the medium of the first media guide; and the drive arrangement being configured to maintain the desired current flow by transferring energy between the energy store and electromagnetic coils.

21. A drive arrangement as claimed in claim 16, wherein the first and second sets of electromagnetic coils are configured to be driven so that each n-th coil generates the same magnetic field at a given time.

22. A drive arrangement as claimed in claim 16, the drive arrangement comprising a first and second set of electromagnetically polarisable pieces; wherein the first set of electromagnetic coils is configured to magnetically polarise the first set of pieces and the second set of electromagnetic coils is configured to magnetically polarise the second set of pieces.

23. A drive arrangement as claimed in claim 1, wherein the medium of each of the first and second media guides is a tangible medium; and the drive arrangement is configured to physically interact with the medium of the first media guide and the medium of the second media guide, the medium of each of the first and second media guides is constituted by a moveable tangible object or set of objects, and the drive arrangement comprising first and second mechanical devices; wherein the first and second mechanical devices are configured to physically interact with a respective one of the media of the first and second media guides to generate the reaction forces; and wherein each mechanical device is a rotary electrical machine comprising a rotor, and the respective rotor is mechanically connected to the respective tangible medium.

24.-26. (canceled)

27. A drive system for moving a body along a path, the drive system comprising a drive arrangement as claimed in claim 16, and the first media guide and second media guide; wherein the first and second media guides each comprise a set of electromagnetic coils, the first and second media guides being configured to control current flowing through their respective electromagnetic coils to cause the generation of the media of the first and second media guides, and the first and second media guides being configured to control current flowing though their respective electromagnetic coils so that a desired current flow is maintained in each of the electromagnetic coils so as to control their respective magnetic field wave.

28.-43. (canceled)
